(19) United States
(12) Patent Application Publication
(10) Pub. No.: US 2010/0187837 A1
(43) Pub. Date: Jul. 29, 2010

(54) ACTUATION DEVICE FOR A COVER OF A BODY OPENING OF A MOTOR VEHICLE

(76) Inventors: Andreas Danner, Wolfsburg (DE); Bernd Winkler, Lehre (DE); Norbert Mayer, Ingolstadt (DE); Stephan Meyer, Adelschlag (DE)

Correspondence Address: King & Spalding LLP, 401 Congress Avenue, Suite 3200, Austin, TX, 78701, US

(21) Appl. No.: 12/529,880

(22) PCT Filed: Nov. 17, 2007
(86) PCT No.: PCT/EP07/09958

§ 371 Date: Mar. 5, 2010

(30) Foreign Application Priority Data
Mar. 9, 2007 (DE) 10-2007-011-541.7

(51) Int. Cl. E05C 1/12

(52) U.S. Cl. 292/164

(57) ABSTRACT

An actuation device (1) for a cover of a body opening of a motor vehicle has a locking pin (5) guided axially in a housing (3), and a control device (11) for controlling an opening range of the locking pin (5). The control device (11) is disposed laterally next to the locking pin (5) and kinematically connected to the locking pin (5).

### CROSS-REFERENCE TO RELATED APPLICATIONS

This application is a U.S. National Stage Application of International Application No. PCT/EP2007/009958 filed Nov. 17, 2007, which designates the United States of America, and claims priority to German Application No. 10 2007 011 541.7 filed Mar. 9, 2007, the contents of which are hereby incorporated by reference in their entirety.

### TECHNICAL FIELD

The present invention relates to an actuation device for a cover of a body opening of a motor vehicle comprising a locking pin guided axially in a housing.

### BACKGROUND

Such an actuation device is known from DE 101 48 199 A1. The known actuation device uses a so called push-push-mechanism. Here, the components required for the axial guidance and control of the locking pin are disposed underneath the locking pin, so that the construction dimensions of the single components are summed up. It is a disadvantage of this design, that the opening range of the locking pin is dependent on the summed up overall construction dimension of the components in such an axial configuration. With a compact construction of the respective assembly environment this leads to a high limitation of the maximum travel height selectable.

### SUMMARY

According to various embodiments, an actuation device can be provided, in which an opening range is no more dependent on the overall construction dimension of the components interacting for the opening range and is much less dependent on the compact construction of the respective assembly environment.

According to an embodiment, an actuation device for a cover of a body opening of a motor vehicle may comprise a locking pin axially controlled in a housing and a control device for controlling an opening range of the locking pin, wherein the control device is positioned laterally next to the locking pin and is kinematically connected to the locking pin.

According to a further embodiment, the kinematic connection can be carried out by means of a power transmission element comprising a transmission ratio which may be predetermined. According to a further embodiment, the opening range of the locking pin can be adjustable by means of the transmission ratio. According to a further embodiment, the power transmission element may have an axis of rotation. According to a further embodiment, the power transmission element may be a lever formed as a rocker. According to a further embodiment, the power transmission element may engage the control device by means of a first arm. According to a further embodiment, the power transmission element may engage the locking pin by means of a second arm. According to a further embodiment, the first arm can be formed as a lever spring. According to a further embodiment, the first arm may support a control pin at its free end for engaging the control device. According to a further embodiment, the second arm may comprise a pivot bearing with its free end for engaging the locking pin. According to a further embodiment, the control device can be a control curve supported in a pivot bearing. According to a further embodiment, a spring element can be disposed in the housing of the locking pin which preloads the locking pin in an opening position of the cover.

### BRIEF DESCRIPTION OF THE DRAWINGS

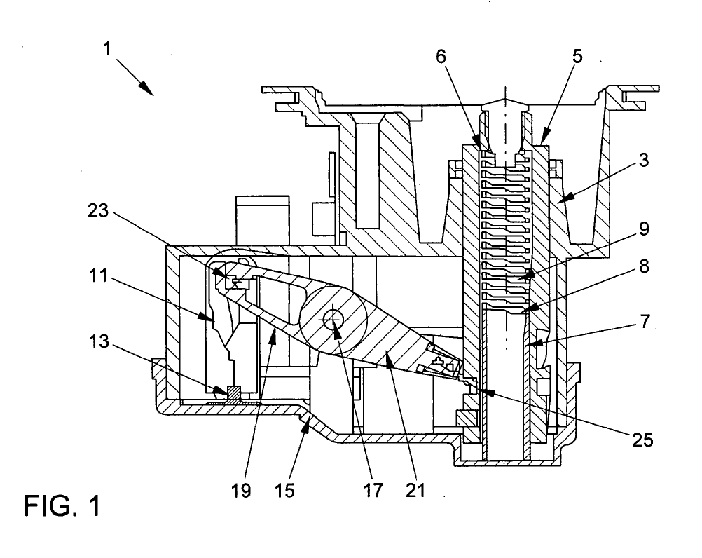

An embodiment is described in more detail in the following by means of FIG. 1 which shows a schematic cross-sectional view of an actuation device.

### DETAILED DESCRIPTION

According to various embodiments, the control device can be disposed laterally next to the locking pin and kinematically connected to the locking pin.

The actuation device according to various embodiments therefore has the advantage that the components interacting to provide the opening range interact in the lowest available space and that the construction dimension only depends on one component, that is to say the housing.

A further advantage exists in that the kinematic connection is carried out by means of a power transmission element whose transmission ratio may be predefined. Thus it is feasible to adapt the power transmission according to the respective conditions.

Furthermore, it is an advantage that the opening range of the locking pin is adjustable by means of the transmission ratio and therefore may be adapted to different situations.

In an embodiment the power transmission element has an axis of rotation. Thereby a number of embodiments arise for the power transmission element. In an embodiment the power transmission element is a lever formed as a rocker. Using this construction an axial movement may be transmitted to the locking pin in a space saving manner. Thus, the opening range of the locking pin may be defined depending on the construction of the lever.

In a further embodiment the power transmission element engages the control device with a first arm, wherein the first arm is formed as a spring element. By means of this technique the first arm is preloaded in the direction of the control curve, so that an approach of predefined switching stages and hold points of the control curve may be allowed for in a secure manner.

In a further embodiment the first arm has a control pin at its free end which engages the control device. This ensures a secure guidance of the first arm in the control curve.

An actuation device 1 for a cover of a body opening of a motor vehicle, in particular for a fuel filler door, is depicted schematically in the figure. In a housing 3 a locking pin 5 is movably accommodated and guided in the housing 3. A guiding pin 7 engages the housing 3 in axial arrangement with the locking pin 5 which also serves for the axial guidance of the locking pin 5. Disposed between the guiding pin 7 and the locking pin 5 is a spring element 9 which preloads the locking pin 5 to an opening position of a cover and for the implementation of an opening range, respectively. In the present embodiment the spring element 9 is a helical spring, which is supported in an end face 8 of the guiding pin 7 with one end and on an inner ring shoulder 6 of the locking pin 5 with its other end. A control device 11 is disposed laterally next to the locking pin 5 and next to the housing 3, respectively, which is depicted as a control curve in the present embodiment. The control device 11 formed as a control curve in the present case is disposed about parallel to the longitudinal axis of the locking pin 5 and has a pivot bearing 13 at its lower end. Disposed between the control device 11 and the locking pin 5 is a power transmission element 15. The power transmission element 15 is to establish a kinematic connection between the control device 11 and the locking pin 5. Therefore, the power transmission arrangement 15 may be formed in a manner known to a person skilled in the art and which provides such a kinematic connection. The power transmission arrangement 15 is constructed as a lever in the present embodiment and particularly as a rocker. For this purpose the power transmission arrangement 15 comprises an axis of rotation 17, a first arm 19 and a second arm 21. The first arm 19 is formed as a spring element and supports a control pin 23 at its free end. The first arm 19 engages the control curve of control device 11 by means of control pin 23. By means of forming the first arm 19 as a spring element, control pin 23 is forced into the control curve. By means of the pivoting bearing of control device 11 in pivot bearing 13 it may follow the pivoting movement of the lever.

The second arm 21 forms a pivot bearing 25 at its free end with which it engages locking pin 5. By means of an appropriate selection of the length of the arm and taking into account the lever principle it is feasible to adjust a transmission ratio at the power transmission element 15. By means of selecting an appropriate area of attack at locking pin 5 and by means of selecting an appropriate length of the arm at the power transmission element the opening range of locking pin 5 may be adjusted. In another embodiment, a similar adjustability would be provided if the power transmission element 15 would be a transmission gearing of cog wheels and/or toothed racks.

Using the present construction the construction dimensions of control device 11, power transmission arrangement 15 and locking pin 5 do not sum up, such that only the construction dimension of housing 3 is relevant for the overall construction dimension. The mode of operation of actuation device 1 is the following:

During operation of the locking pin 5 by means of a fuel filler door locking pin 5 is forced downward by spring element 9. At the same time the power transmission element 15 formed as a lever is pivoted around its axis of rotation 17, so that control pin 23 passes through the control curve. While passing through the control curve control pin 23 reaches predefined switching points and notches in the control curve. This way locking pin 5 is controlled and locked in a space saving manner.

### REFERENCE NUMERALS

1 actuation device
3 housing
5 locking pin
6 inner ring shoulder
7 guiding pin
8 end face
9 spring element
11 control device
13 pivot bearing
15 power transmission element
17 axis of rotation
19 first arm
21 second arm
23 control pin
25 pivot bearing

What is claimed is:

1. An actuation device for a cover of a body opening of a motor vehicle, comprising a locking pin axially controlled in a housing and a control device for controlling an opening range of the locking pin,
wherein
the control device is positioned laterally next to the locking pin and is kinematically connected to the locking pin.

2. The actuation device according to claim 1,
wherein
the kinematic connection is carried out by means of a power transmission element comprising a transmission ratio which may be predetermined.

3. The actuation device according to claim 2,
wherein
the opening range of the locking pin is adjustable by means of the transmission ratio.

4. The actuation device according to claim 2, wherein
the power transmission element has an axis of rotation.

5. The actuation device according to claim 4, wherein
the power transmission element is a lever formed as a rocker.

6. The actuation device according to claim 5, wherein
the power transmission element engages the control device by means of a first arm.

7. The actuation device according to claim 5, wherein
the power transmission element engages the locking pin by means of a second arm.

8. The actuation device according to claim 6, wherein
the first arm is formed as a lever spring.

9. The actuation device according to claim 6, wherein
the first arm supports a control pin at its free end for engaging the control device.

10. The actuation device according to claim 7, wherein
the second arm comprises a pivot bearing with its free end for engaging the locking pin.

11. The actuation device according to claim 1, wherein
the control device is a control curve supported in a pivot bearing.

12. The actuation device according to claim 1, wherein
a spring element is disposed in the housing of the locking pin which preloads the locking pin in an opening position of the cover.

13. A method of operating an actuation device for a cover of a body opening of a motor vehicle, comprising the steps of:
axially controlling a locking pin in a housing and controlling an opening range of the locking pin by a control device, and
positioning the control device laterally next to the locking pin and connecting the control device kinematically to the locking pin.

14. The method according to claim 13, wherein the kinematic connection is carried out by means of a power transmission element comprising a transmission ratio which may be predetermined.

15. The method according to claim 14, wherein the opening range of the locking pin is adjustable by means of the transmission ratio.

16. The method according to claim 13, wherein the power transmission element has an axis of rotation, the power transmission element is a lever formed as a rocker, and the power transmission element engages the control device by means of a first arm.

17. The method according to claim 16, wherein the power transmission element engages the locking pin by means of a second arm.

18. The method according to claim 16, wherein the first arm is formed as a lever spring.

19. The method according to claim 17, wherein the second arm comprises a pivot bearing with its free end for engaging the locking pin.

20. The method according to claim 13, further comprising the step of disposing a spring element in the housing of the locking pin which preloads the locking pin in an opening position of the cover.
